(19) United States
(12) Patent Application Publication
(10) Pub. No.: US 2020/0028285 A1
(43) Pub. Date: Jan. 23, 2020

(54) Detachable Carbon-Fiber Conductive Rail

(71) Applicants: Ke-Han Yu, Beijing (CN); Tao Wang, Beijing (CN); Chun Li, Beijing (CN); Hai-Tao Zhou, Beijing (CN)

(72) Inventors: Ke-Han Yu, Beijing (CN); Tao Wang, Beijing (CN); Chun Li, Beijing (CN); Hai-Tao Zhou, Beijing (CN)

(21) Appl. No.: 16/038,190

(22) Filed: Jul. 18, 2018

(51) Int. Cl. H01R 9/26; H01R 33/94; H02B 1/052

(52) U.S. Cl. CPC H01R 9/2608; H02B 1/205; H02B 1/052; H01R 33/94

(57) ABSTRACT

This invention refers to a detachable carbon-fiber conductive rail in the technical field of conductive rail. The conductive rail above has a main body that consists of a long connecting pipe module linked with an elastic sheet module at one end, and at the other end of the elastic sheet module far away from the long connecting pipe module, there is a short connecting pipe module. In this invention, the long connecting pipe module, the elastic sheet module and the short connecting pipe module are connected in sequence. In this way, operators can dismount and install the modules easily to improve efficiency of installation and bring down the costs. As for this detachable carbon-fiber conductive rail, multiple long connecting pipe modules, elastic sheet modules and short connecting pipe modules can be connected together in sequence to shape several conductive rails. The installation circuits can be curved, straight or annular. Both the long and short connecting pipes are made of carbon-fiber composites which are characterized by strong resistance to thermal shock, corrosion and radiance.

### TECHNICAL FIELD

This invention refers to a detachable carbon-fiber conductive rail in the technical field of conductive rail.

### TECHNICAL BACKGROUND

Basically, conductive rails in the market have two shortcomings. First, professional engineering team is required for installation, and arbitrary dismounting and installation is forbidden. This will increase installation costs and limit number of uses. Since most of existing products are made of stainless steel or aluminum alloy that is heavy and not tenacious, they cannot be dismounted without professionals because of the need for bolt connection. Second, the conductive rails are straight rather than spatially curved, which will limit the spatial scope of installation. The intelligent lamp armed with this product is featured with intelligent tracking, able to move freely in accordance with images and gestures. Existing rails equipped with fixed and rigid structure in the market are inclined toward intelligent linear motion, thus incapable of moving to the specific place as required. In view of this, a detachable carbon-fiber conductive rail is proposed.

### INVENTION CONTENTS

This invention is intended to provide a detachable carbon-fiber conductive rail for the purpose of solving the difficulty in dismounting conductive rail, as mentioned in the part of technical background.

For this sake, this invention puts forward technical schemes as follows:

The detachable carbon-fiber conductive rail has a main body that consists of a long connecting pipe module linked with an elastic sheet module at one end, and at the other end of the elastic sheet module far away from the long connecting pipe module, there is a short connecting pipe module.

Preferably, the long connecting pipe module and the elastic sheet module are hollow.

Preferably, the long connecting pipe module consists of a long connecting pipe that is equipped with locating holes at the upper and lower sides of its two ends. Both the upper and lower ends of the long connecting pipe are furnished with long copper bars. There is a piece of gum between the long connecting pipe and the long copper bar, which is aimed at connecting the long copper bar with the long connecting pipe.

Preferably, the long copper bar includes a main body. The two ends of long copper bar's main body are welded with U-shaped bended parts. There is a hook parallel to copper bar's main body at one end of the U-shaped bended parts far away from copper bar's main body, and the bended part is armed with a threaded hole at one side.

Preferably, the elastic sheet module consists of the first connecting ring and the second connecting link that are located symmetrically. At one side of the joint between the first connecting ring and the second connecting link, both the upper and lower ends are equipped with a bar. A the other side of the joint between the first connecting ring and the second connecting link, both the upper and lower ends are furnished with a slot. The bar is matched up with the slot in size and therefore can be connected together.

Preferably, there are elastic sheet installation areas and buffer fixing areas at one end of both the first connecting ring and the second connecting link far away from the long connecting pipe. The elastic sheet installation area is equipped with an elastic sheet and the buffer fixing area is furnished with a buffer. The elastic sheet connected with the first connecting ring via buffer also has a threaded hole

Preferably, the elastic sheet which goes through two threaded holes successively by way of lock screw is screwed with one end of the long copper bar.

Preferably, the short connecting pipe module is made up of a short connecting pipe. At the middle part of its two sides, there is a symmetrically located fixing groove, which is armed with a short copper sheet.

Preferably, the long connecting pipe and the short connecting pipe are made of carbon fiber composite.

Preferably, both the long copper bar and the short copper sheet are made of C7025 TM03 high-conductivity copper sheet with the thickness of 0.4-0.5 mm.

Compared with existing technology, the beneficial results of this invention are as follows:

1. As for the detachable carbon-fiber conductive rail, the long connecting pipe module, the elastic sheet module and the short connecting pipe module are connected in sequence. In this way, the operators can dismount and install the modules easily to improve efficiency of installation and bring down the costs.

2. As for this detachable carbon-fiber conductive rail, multiple long connecting pipe modules, elastic sheet modules and short connecting pipe modules can be connected together in sequence to shape several conductive rails. The installation circuits can be curved, straight or annular.

3. Both the long and short connecting pipes are made of carbon-fiber composites, which are transformed from organic fiber after a series of heat treatment processes. It is an inorganic high-performance fiber with the carbon content of more than 90% as well as a new material with good mechanical performance. The carbon-fiber composite shows the inherent characteristics of carbon materials. It is as soft as carbon fiber and machineable. In terms of strength, it is five times better than steel. Characterized by strong resistance to heat, thermal shock, corrosion and radiance, carbon fiber composite is energy-saving and not easy to deform. Besides, its weight is light, only equal to ⅕ of steel.

### ILLUSTRATIONS ON FIGURES

FIG. 1: schematic diagram for overall structure of this invention

FIG. 2: explosive view for long connecting pipe module of this invention

FIG. 3: amplified schematic diagram for A of this invention

FIG. 4: explosive view for short connecting pipe module of this invention

FIG. 5: schematic diagram for short connecting pipe module of this invention

In these figures: 1. conductive rail's main body; 2. long connecting pipe module; 21. long connecting pipe; 22. locating hole; 23. long copper bar; 231. copper bar's main body; 232. bended part; 233. hook; 234. threaded hole; 24. long copper bar's gum; 3. elastic sheet module; 31. the first connecting ring; 32. bar; 33. the second connecting ring; 34. slot; 35 elastic sheet; 36. buffer; 37 lock screw; 38. elastic sheet installation area; 39. buffer fixing area; 4. short connecting pipe module; 41. short connecting pipe; 42. short copper sheet's fixing groove; 43. short copper sheet

### SPECIFIC IMPLEMENTATION MODES

The figures above are used to clearly and fully describe the technical schemes of the examples in this invention. Obviously, the examples described herein only constitute a part rather than all of the examples in this invention. Based on the examples of this invention, all other examples obtained by ordinary technicians in this field without paying creative efforts shall fall under the protective scope of this invention.

According to descriptions of this invention, there is a need to understand that the terminologies concerning orientation or position are based on the orientation or position mentioned by the figures, including “center, longitudinal direction, transverse direction, length, width, thickness, up, down, front, back, left, right, vertical, horizontal, top, bottom, inside, outside, clockwise, and anticlockwise”. This aims to provide convenience for descriptions on this invention and simplified descriptions rather than suggest that there must be a specific position for the equipment or components described, or the equipment or components must be made and operated at a specific position. Thus, the terminologies above shall not be construed as a constraint over this invention.

Additionally, the terminologies “the first” and “the second” are only intended to describe the aim. They shall not be construed as an indication or a hint for relative importance, or an implicit indication for the number of technical characteristics. The words “the first” and “the second” explicitly or implicitly indicate that there is one or more characteristics of such type. In the description of this invention, multiple means two or more, unless otherwise explicitly specified.

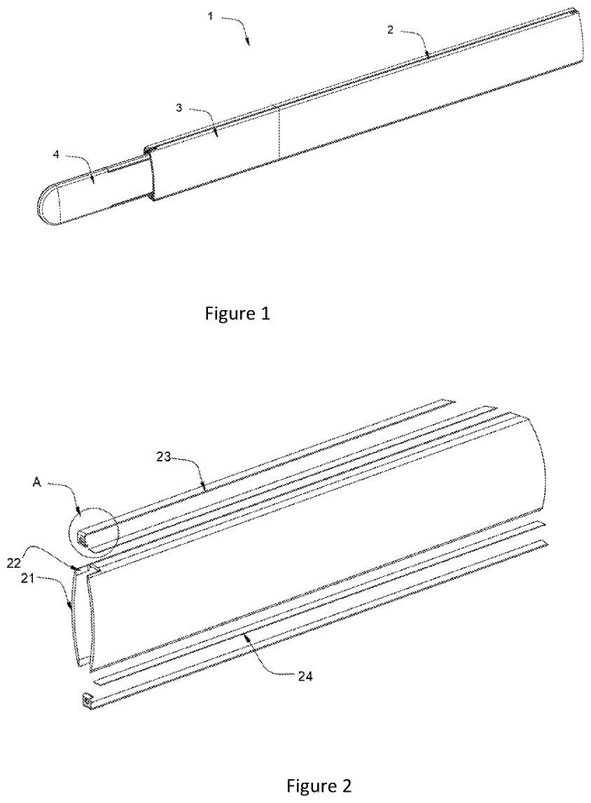

As can be seen in FIGS. 1-5, this invention brings forth a technical scheme:

As shown by FIG. 1, the detachable carbon-fiber conductive rail has a main body (1) that consists of a long connecting pipe module (2) linked with an elastic sheet module (3) at one end, and at the other end of the elastic sheet module (3) far away from the long connecting pipe module (2), there is a short connecting pipe module(4).

It is worth noticing that the long connecting pipe module (2) and the elastic sheet module (3) are hollow.

It is worth noticing that according to FIG. 2, the long connecting pipe module (2) consists of a long connecting pipe (21) that is equipped with locating holes (22) at the upper and lower sides of its two ends. Both the upper and lower ends of the long connecting pipe (21) are furnished with long copper bars (23). There is a piece of gum (24) between the long connecting pipe (21) and the long copper bar (23), which is aimed at connecting the long copper bar (23) with the long connecting pipe (21).

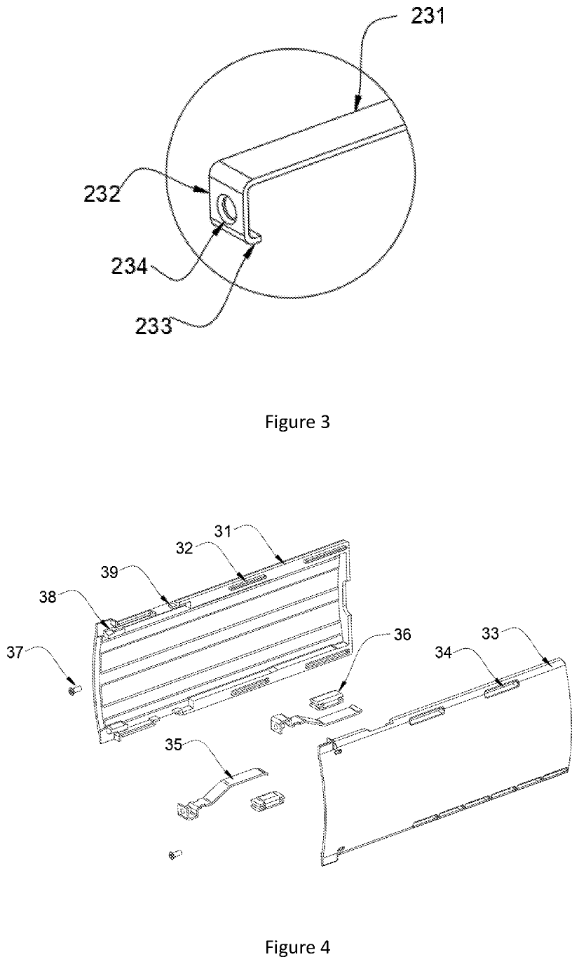

As revealed by FIG. 3, the long copper bar (23) includes a main body (231). The two ends of long copper bar's main body (231) are welded with U-shaped bended parts (232). There is a hook (233) parallel to copper bar's main body (231) at one end of the U-shaped bended parts (232) far away from copper bar's main body (231), and the bended part (232) is armed with a threaded hole (234) at one end.

It is worth noticing that according to FIG. 4, the elastic sheet module (3) consists of the first connecting ring (31) and the second connecting link (33) that are located symmetrically. At one side of the joint between the first connecting ring (31) and the second connecting link (33), both its upper and lower ends are equipped with a bar (32). A the other side of the joint between the first connecting ring (31) and the second connecting link (33), both its upper and lower ends are furnished with a slot (34). The bar (32) is matched up with the slot (34) in size and therefore can be connected together.

Additionally, according to FIG. 3, there are elastic sheet installation areas (38) and buffer fixing areas (39) at one end of both the first connecting ring (31) and the second connecting link (33) far away from the long connecting pipe (21). The elastic sheet installation area (38) is equipped with an elastic sheet (35) and the buffer fixing area (39) is furnished with a buffer (36). The elastic sheet (35) connected with the first connecting ring (31) via buffer (36) also has a threaded hole (234).

In this example, the elastic sheet (35) which goes through two threaded holes (234) successively by way of lock screw (37) is screwed with one end of the long copper bar (23).

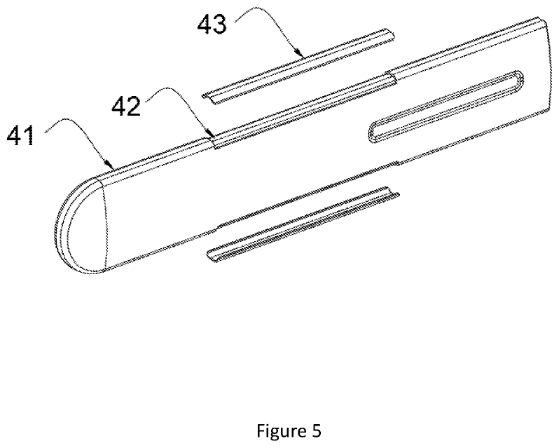

It is worth mentioning that according to FIG. 5, the short connecting pipe module (4) is made up of a short connecting pipe (41). At the middle part of its two sides, there is a symmetrically located fixing groove (42), which is armed with a short copper sheet (43).

In this example, both the long connecting pipe (21) and the short connecting pipe (41) are made of carbon-fiber composites, which are transformed from organic fiber after a series of heat treatment processes. It is an inorganic high-performance fiber with the carbon content of more than 90% as well as a new material with good mechanical performance. The carbon-fiber composite shows the inherent characteristics of carbon materials. It is as soft as carbon fiber and machineable. In terms of strength, it is five times better than steel. Characterized by strong resistance to heat, thermal shock, corrosion and radiance, carbon fiber composite is energy-saving and not easy to deform. Besides, its weight is light, only equal to ⅕ of steel.

In this example, both the long copper bar (23) and the short copper sheet (43) are made of C7025 TM03 high-conductivity copper sheet with the thickness of 0.4-0.5 mm C7025 TM03 copper sheet superior in electric conduction, heat conduction, anticorrosion, and processability can be used for welding and brazing. It has few impurities that can decrease electric and thermal conductivity, as well as little oxygen that exerts insignificant influence on electric and thermal conduction and processability. This can ensure stable performance and prolong service life.

1. First, the elastic sheet (35) and the buffer (36) shall be put into the plastic first connecting ring (31); then, the slot (34) of the second connecting ring (33) shall be connected with the bar (32) of the first connecting ring (31) to assemble a complete elastic sheet module (3).

2. One end of two elastic sheet modules (3) that are assembled and far away from elastic sheet installation area (38) shall be inserted into two ends of long connecting pipe module (2), respectively, so as to guarantee same assembly at two ends of the long connecting pipe module (2).

3. Two long copper bars (23) are stuck to the upper and lower sides of long connecting pipe module (2) through long copper bar's gum (24).

4. Elastic sheet (35) is installed within elastic sheet installation area (38) and buffer (36) is used to fix elastic sheet (35); meanwhile, there is a need to ensure the conduction between long copper bar (23) and elastic sheet (7).

5. Finally, two short connecting pipe modules are inserted into elastic sheet modules (3). Meanwhile, there is a need to ensure the conduction between long copper bar (23) and short copper sheet (43) through elastic sheet (7). The assembling parts can be seen in FIG. 1.

As for this detachable carbon-fiber conductive rail, multiple long connecting pipe modules (2), elastic sheet modules (3) and short connecting pipe modules (4) can be connected together in sequence to shape several conductive rails. The installation circuits can be curved, straight or annular.

The basic principles, major characteristics and advantages of this invention are revealed and described above. The technicians in this industry shall understand that this invention is not restricted by the examples above. The examples above and described in this specification are only the preferred examples of this invention rather than a constraint over this invention. Based on the tenet and scope of this invention, various changes and improvements that will be made shall fall within the protective scope of this invention. This invention requires that the protective scope be defined by claims attached and its equivalent.

1. The detachable carbon-fiber conductive rail has a main body (1) that consists of a long connecting pipe module (2) linked with an elastic sheet module (3) at one end, and at the other end of the elastic sheet module (3) far away from the long connecting pipe module (2), there is a short connecting pipe module (4).

2. As described by claim 1, the long connecting pipe module (2) and the elastic sheet module (3) of the detachable carbon-fiber conductive rail are hollow.

3. As described by claim 1, the long connecting pipe module (2) of the detachable carbon-fiber conductive rail consists of a long connecting pipe (21) that is equipped with locating holes (22) at the upper and lower sides of its two ends. Both the upper and lower ends of the long connecting pipe (21) are furnished with long copper bars. There is a piece of gum (24) between the long connecting pipe (21) and the long copper bar (23), which is aimed at connecting the long copper bar (23) with the long connecting pipe (21).

4. As described by claim 3, the detachable carbon-fiber conductive rail is characterized by a long copper bar (23) that includes a main body (231). The two ends of long copper bar's main body (231) are welded with U-shaped bended parts (232). There is a hook (233) parallel to copper bar's main body (231) at one end of the U-shaped bended parts (232) far away from copper bar's main body (231), and the bended part (232) is armed with a threaded hole at one end (234).

5. As described by claim 4 concerning the detachable carbon-fiber conductive rail, its elastic sheet module (3) consists of the first connecting ring (31) and the second connecting link (33) that are located symmetrically. At one side of the joint between the first connecting ring (31) and the second connecting link (33), both its upper and lower ends are equipped with a bar (32). At the other side of the joint between the first connecting ring (31) and the second connecting link (33), both its upper and lower ends are furnished with a slot (34). The bar (32) is matched up with the slot (34) in size and therefore can be connected together.

6. As described by claim 5 concerning the detachable carbon-fiber conductive rail, there are elastic sheet installation areas (38) and buffer fixing areas (39) at one end of both the first connecting ring (31) and the second connecting link (33) far away from the long connecting pipe (21). The elastic sheet installation area (38) is equipped with an elastic sheet (35) and the buffer fixing area (39) is furnished with a buffer (36). The elastic sheet (35) connected with the first connecting ring (31) via buffer (36) also has a threaded hole (234).

7. As described by claim 6 concerning the detachable carbon-fiber conductive rail, the elastic sheet (35) which goes through two threaded holes (234) successively by way of lock screw (37) is screwed with one end of the long copper bar (23).

8. As described by claim 7 concerning the detachable carbon-fiber conductive rail, the short connecting pipe module (4) is made up of a short connecting pipe (41). At the middle part of its two sides, there is a symmetrically located fixing groove(42), which is armed with a short copper sheet (43).

9. As described by claim 8 concerning the detachable carbon-fiber conductive rail, the long connecting pipe (21) and the short connecting pipe (41) are made of carbon fiber composite.

10. As described by claim 8 concerning the detachable carbon-fiber conductive rail, both the long copper bar (23) and the short copper sheet (43) are made of C7025 TM03 high-conductivity copper sheet with the thickness of 0.4-0.5 mm.
